(19) United States
(12) Patent Application Publication
(10) Pub. No.: US 2016/0154532 A1
(43) Pub. Date: Jun. 2, 2016

(54) LIGHT GUIDE PANEL INCLUDING DIFFRACTION GRATINGS

(71) Applicant: HEWLETT-PACKARD DEVELOPMENT COMPANY, LP, Houston, TX (US)

(72) Inventor: Robert Campbell, Cupertino, CA (US)

(21) Appl. No.: 14/905,136

(22) PCT Filed: Jul. 19, 2013
(86) PCT No.: PCT/US2013/051304

§ 371 Date: Jan. 14, 2016

(51) Int. Cl. G06F 3/042; G06F 3/041; F21V 8/00

(52) U.S. Cl. CPC G06F 3/0421; G02B 6/0016; G02B 6/0036; G02B 6/0068; G06F 3/0412; G06F 2203/04109

(57) ABSTRACT

An example provides an apparatus including a light guide panel with a plurality of diffraction gratings to cause light to propagate within the light guide panel by total internal reflection and scatter light in response to a presence of an object adjacent to the light guide panel.

### BACKGROUND

Touch displays may be implemented in a variety of ways. Some displays enlist capacitive or resistive touch sensors in which a touch event to the display causes an electrical change to indicate the touch. Other displays may use an optical approach such as for example, frustrated total internal reflection (FTIR) with image processing to determine the location of a touch event.

With FTIR, light propagates through a light guide panel at a critical angle, and when a user touches the panel with a finger, the light escapes and is reflected at the point of contact due to the finger having a higher refractive index than the panel. When the light escapes, or scatters, a camera may register the reflections or a light detector may instead detect an attenuation of the propagated light to determine that a touch event has occurred.

### BRIEF DESCRIPTION OF THE DRAWINGS

The detailed description section references the drawings, wherein:

FIG. 1 is a block diagram of an example apparatus including a light guide panel with diffraction gratings;

FIG. 2A and FIG. 2B illustrate an example of light propagation by another example apparatus including a light guide panel with diffraction gratings:

FIG. 3 illustrates another example of light propagation by another example apparatus including a light guide panel with diffraction gratings;

FIGS. 4-8 illustrate various other example apparatuses including a light guide panel with diffraction gratings;

FIG. 9 is a block diagram of an example system including a light guide panel with diffraction gratings; and

FIG. 10 is a flow diagram of an example method implementing an apparatus including a light guide panel with diffraction gratings;

all in which various embodiments may be implemented.

Certain examples are shown in the above-identified figures and described in detail below. The figures are not necessarily to scale, and various features and views of the figures may be shown exaggerated in scale or in schematic for clarity and/or conciseness.

### DETAILED DESCRIPTION OF EMBODIMENTS

An optical based touch display implemented using frustrated total internal reflection (FTIR) sometimes include a number of light emitters optically coupled to a light guide panel by at least one opto-coupler. The opto-coupler causes light from the light emitters to be oriented into the proper angle, the critical angle, so that the light reflects and propagates internal to the light guide panel rather than having some portion of the light passing vertically through the light guide panel to be lost for the purposes of touch detection.

Opto-couplers, while beneficial in orienting light into the critical angle, may sometimes substantially increase the size of the display at least in that the opto-coupler is disposed between the light emitters and the light guide panel. While this increase in size may be acceptable for some applications, other applications may see benefit in down-sizing.

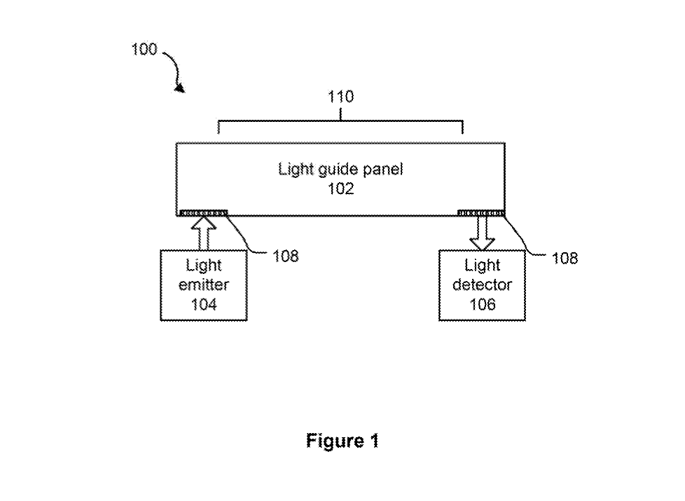

FIG. 1 illustrates an example apparatus 100 including a light guide panel 102, a light emitter 104 adjacent to the light guide panel 102 to transmit light to the light guide panel 102, and a light detector 106 adjacent to the light guide panel 102 to detect light propagated by the light guide panel 102. The light guide panel 102 may include a plurality of diffraction gratings 108 and may include a touch area 110 to receive a touch input. In various implementations the touch area 110 may be defined by a periphery of a first major surface, and the light emitter 104 and the light detector 106 may be disposed adjacent to the second major surface, opposite the first major surface, as illustrated As used herein, the term “major surface” may be used to define the larger area surface of the light guide panel 102, which may have two opposing major surfaces whose length and width is larger than a thickness (i.e., the distance between the major surfaces) of the light guide panel 102. Likewise, a “minor surface” may refer to the surface(s) between the two opposing major surfaces.

The light emitter 104 may produce light in the form of at least one light beam. The light emitter 104 may include, for example, one or more lasers, one or more light emitting diodes (“LEDs”), and so on.

The light from the light emitter 104 may be received directly by the light guide panel 102 via a plurality of diffraction gratings 108 of the light guide panel 102 without the use of an opto-coupler. The plurality of diffraction gratings 108 may scatter light from the light emitter 104 into a corresponding plurality of directional light beams into the light guide panel 102 at an angle to propagate the light by total internal reflection within the light guide panel 102. A presence of an object adjacent to a touch area 110 of the light guide panel 102 (referred to herein as a “touch event”) may cause the propagating light to scatter in accordance with FTIR with a corresponding change in the quantity of light reaching the light detector 106. The detected change may allow for determining a location of the touch event, as described more fully herein.

As the diffraction gratings 108 allow for orienting light into the critical angle suitable for FTIR, the apparatus 100 may be constructed with less complexity as compared to apparatuses including light guide panels without diffraction gratings. For example, light guide panels described herein may allow for avoiding the use of bulky opto-couplers to orient light beams into the proper angle for total internal reflection. As such, the light emitter 104 and the light detector 106 may be arranged adjacent to the light guide panel 102, which may allow for a more compact design. In some implementations, the light emitter 104 and/or the light detector 106 may in fact abut against the light guide panel 102.

In various implementations, the apparatus 100 includes a plurality of light emitters 104 and/or a plurality of light detectors 106. In various ones of these implementations, light emitted by one light emitter 104 may be detected by one light detector 106 or multiple light detectors 106 such that the apparatus 100 includes one light detector 106 per light emitter 104, more than one light detector 106 per light emitter 104, or more than one light emitter 104 per light detector 106. In various implementations, the light emitter 104 and/or the light detector 106 may be coupled to the light guide panel 102 by an optically transmissive adhesive, epoxy, or glue, or another coupler such as, for example, edge fasteners or the like, or may transmit the light through an air gap.

Although the illustrated implementation includes diffraction gratings 108 between the light emitter 104 and the light guide panel 102 and also between the light detector 106 and the light guide panel 102, other configurations may be possible. In some implementations, the diffraction gratings 108 may be omitted between the light detector 106 and the light guide panel 102 (illustrated elsewhere).

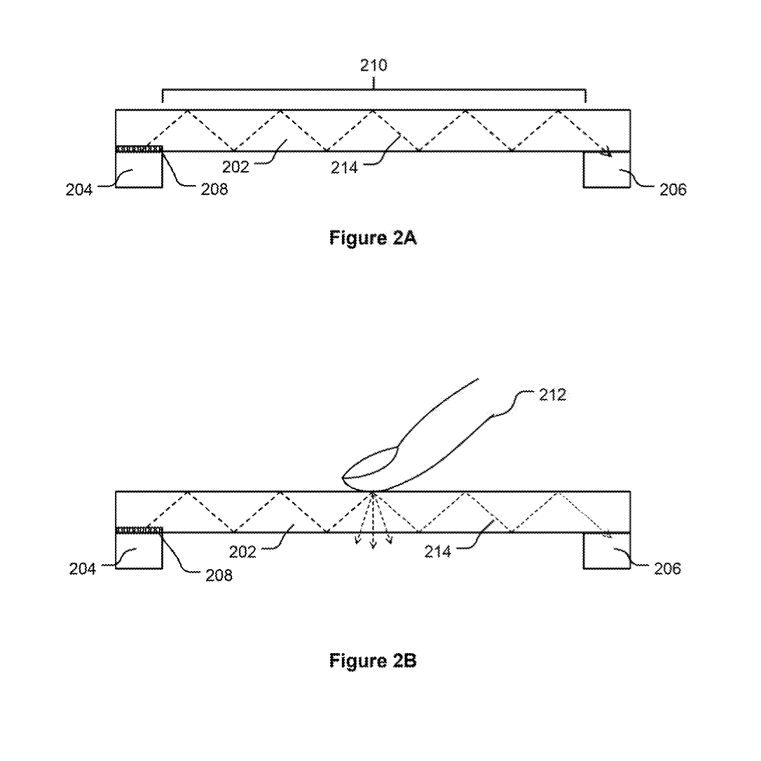

An example of light propagation by a light guide panel, in accordance with various implementations described herein, is illustrated by FIG. 2A and FIG. 26. In FIG. 2A, a light emitter 204 transmits light 214 to a light guide panel 202, via diffraction gratings 208 to cause light 214 to be transmitted into the light guide panel 202 at an angle to propagate light 214 by total internal reflection within the light guide panel 202. A touch event such as, for example, the presence of an object 212 (e.g., a finger) adjacent to the light guide panel 202 may cause the light 214 to scatter, as illustrated in FIG. 2B. The scattering of light 214 by the object 212 may cause an attenuation of the quantity of light 214 that continues to propagate through the light guide panel 202, and thus, detected by the light detector 206. This change in the quantity of light 214 detected by the light detector 206 may indicate to the apparatus 200 that a touch to the touch area 210 the light guide panel 202 has occurred along the path of the light 214.

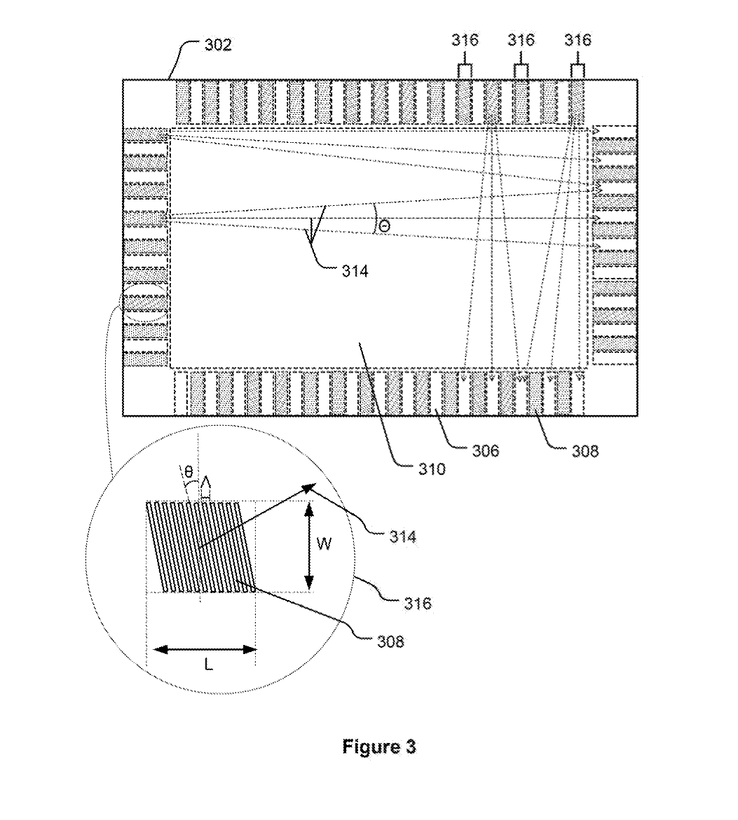

FIG. 3 illustrates another example of light propagation by a light guide panel 302, with example diffraction gratings 308, light emitters (view obstructed here by the diffraction gratings 308), light detectors 306 on the opposite side of the light guide panel 302 (in this case, the underside), and a touch area 310, all shown with hashed lines.

Also illustrated are example representations of paths of light beams 314 from several sets 316 of diffraction gratings 308 also with hashed lines. The individual lashed-line arrows do not necessarily represent individual, separate light beams 314, but may instead represent an angular spread of the light beam 314 paths. It is noted that the light beams 314 may have different angular spreads, shapes, and footprints than that illustrated.

As illustrated, the plurality of diffraction gratings 308 may comprise a plurality of sets 316 of substantially parallel grooves patterned to scatter light into a corresponding plurality of directional light beams 314 into the light guide panel 302. The individual sets 316 of diffraction gratings 318 may be specified by a grating length L, a grating width W, a groove orientation θ, and a pitch Λ. Each set 316 of diffraction gratings 308 may emit a directional light beam 314 with a direction that is controlled by the groove orientation and the grating pitch and with an angular spread ΔΘ that may be controlled by the grating length and width, as follows:

$$ΔΘ \approx \frac{4 λ}{π L} ( \frac{4 λ}{π W} )$$

where λ is the wavelength of the directional light beam 314. The groove orientation, specified by the grating orientation angle θ, and the grating pitch or period, specified by Λ, may control the direction of the directional light beam 314. As such, the individual sets 316 of diffraction gratings 308 may be configured to maximize the amount of light emitted by the light emitter 304 that propagates across the touch area 310 and minimize loss of the light outside of the perimeter of the touch area 310 without dead spots and with touch coverage in the corners of the touch area 310, by effectively steering the light into the touch area 310.

To determine a location of a touch event, individual light detectors 306 may determine a change in a quantity of light expected and the combination of data from the light detectors 306 may provide information on the location of the touch event. For instance, for the apparatus 300 illustrated in FIG. 3, a light detector 306 along one of the horizontal edges (x-axis) and a light detector 306 along one of the vertical edges (y-axis) may determine an attenuation in a quantity of light expected. Combining the x location and the y location may provide coordinates for the touch event.

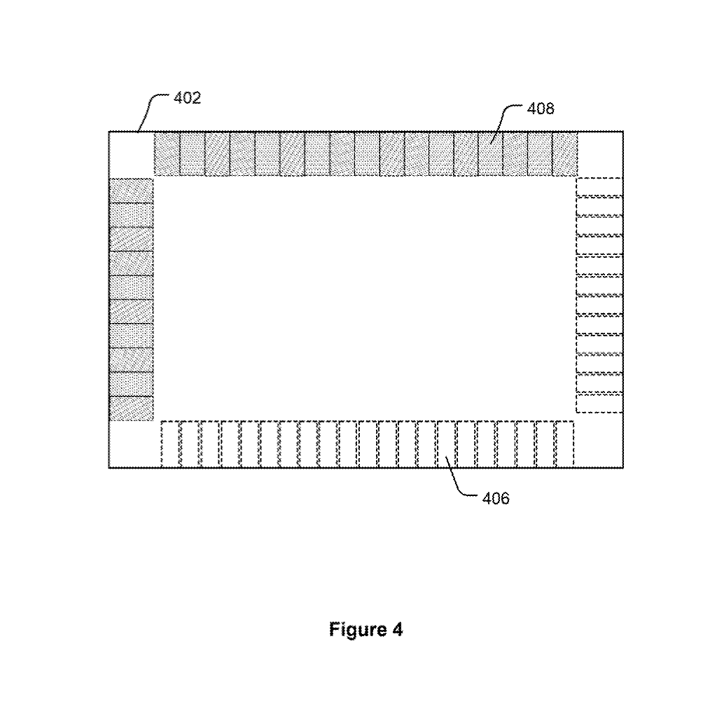

As illustrated in the foregoing examples, the light emitters and light detectors are interleaved along the periphery of the light guide panel adjacent to a major surface of the light guide panel. In various other implementations, the light emitters and light detectors may have a different arrangement. For example, as illustrated in FIG. 4, light emitter(s) (view obstructed by the diffraction gratings 408) may be disposed along two adjacent peripheral edges of the light guide panel 402, and the light detector(s) 306 may be disposed along opposite peripheral edges of the light guide panel 402. In other non-illustrated implementations, the light emitter(s) may be disposed along a first peripheral edge and the light detector(s) disposed along the opposite second peripheral edge. In other non-illustrated implementations, the light emitters and light detectors 306 may be interleaved in some other pattern than that illustrated in FIG. 3. Various other configurations may be possible within the scope of the present disclosure.

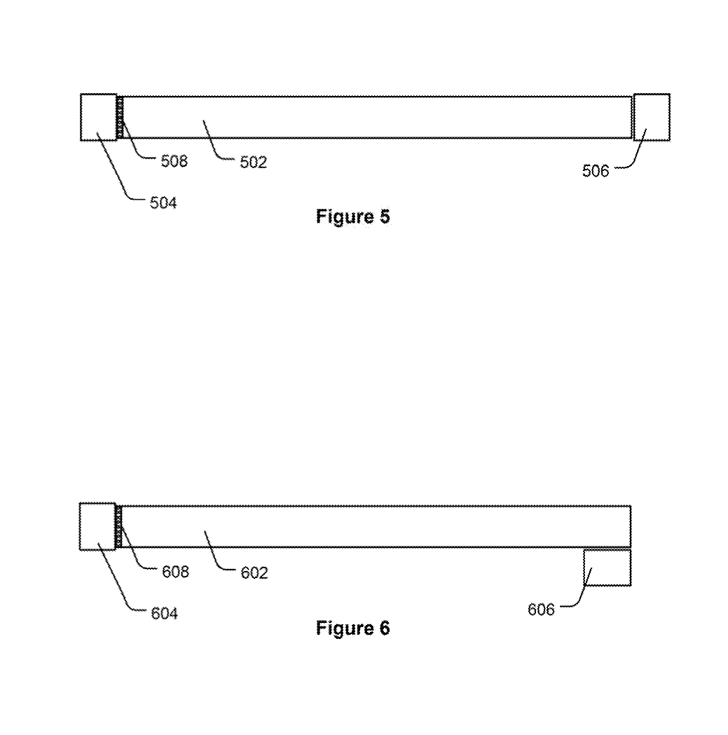

In various implementations, the light emitter(s) and/or light detector(s) may be disposed along a minor surface of the light guide panel, as illustrated in FIG. 5 and FIG. 6. As illustrated in FIG. 5, the light guide panel 502 includes diffraction gratings 508 along a minor surface of the light guide panel 502, with a light emitter 504 adjacent to the minor surface of the light guide panel 502 such that the diffraction gratings 508 are between the light emitter 504 and the light guide panel 502. Likewise, the light detector 506 is disposed adjacent to the opposite minor surface of the light guide panel 502. In other implementations such as the one illustrated in FIG. 6, the light detector 606 may be disposed adjacent to a major surface of the light guide panel 602 while the diffraction gratings 608 and light emitter 604 are disposed along a minor surface of the light guide panel 602. Various other configurations may be possible within the scope of the present disclosure.

The various implementations of diffraction gratings described herein may be formed using any of a number of fabrication operations. In some implementations, the diffraction gratings may be formed by an imprint lithography operation. In some of these implementations, an imprint lithography operation may be performed using a roll-to-roll technique, which may allow for fabrication of the light guide panel in volume. The light guide panel may be imprinted and used a stand-alone display panel or may be attached or laminated to another substrate using a frame or a suitable adhesive, epoxy, or cured glue to form a display panel. In some of the latter examples, the light guide panel may comprise a film that is imprinted with the diffraction gratings and then affixed to another substrate (such as, e.g., a rigid substrate). In various implementations, the light guide panel may comprise any suitable material such as, but not limited to, plastic or glass.

In some implementations, the diffraction gratings may be formed by an additive or subtractive photolithography operation. In some of the former implementations, the diffraction gratings may be formed by masking (with a photoresist, for example), exposure, development, and etching of exposed regions of the light guide panel or deposition of material on exposed regions of the light guide panel to form the diffraction gratings.

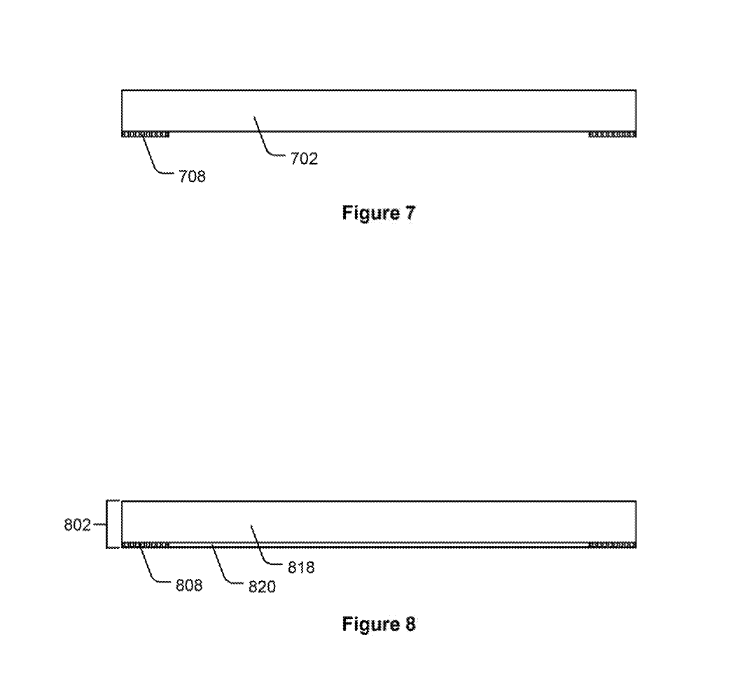

FIG. 7 illustrates an example light guide panel 702 including diffraction gratings 708, which are raised in relation to the remaining surface of the light guide panel 702, as compared to the recessed diffraction gratings of the light guide panel illustrated in FIG. 2A/2B In various implementations, the diffraction gratings 708 of the light guide panel 702 of FIG. 7 may be formed by the photolithography operation described above, FIG. 8 illustrates another example light guide panel 802 in which a film 820 including the diffraction gratings 808 is disposed over a substrate 818 to form the light guide panel 802, Various other configurations may be possible within the scope of the present disclosure.

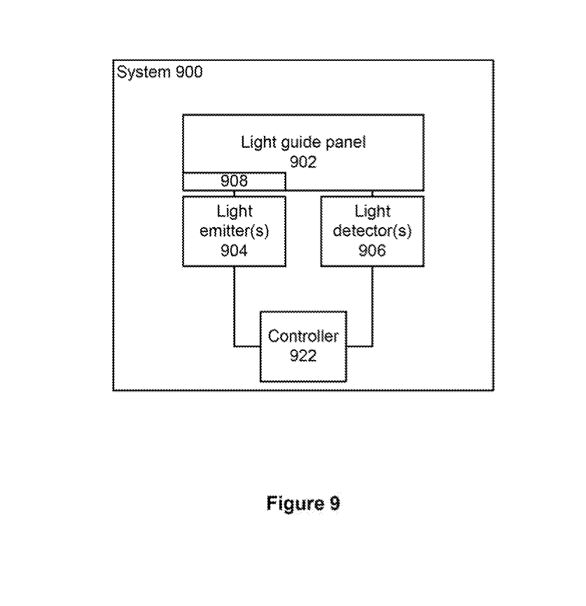

The various light guide panels and apparatuses including such light guide panels described herein may be stand-alone devices or may be incorporated into various types of systems such as system 900 illustrated in FIG. 9. In various implementations, system 900 may be system such as but not limited to, a display device, a desktop computer, a notebook computer, a handheld computer a tablet computer, a convertible computer, a smart phone, a personal digital assistant, a mobile phone, a television, retail point of sale computer, gaming computer, or a digital camera.

As illustrated, the system 900 may include a light guide panel 902 with diffraction gratings 908, at least one light emitter 904 adjacent to the light guide panel 902, and at least one light detector 906 adjacent to the light guide panel 902. The diffraction gratings 908 may, as described herein, cause light to be transmitted into the light guide panel 902 at an angle to propagate light by total internal reflection within the light guide panel 90 and scatter light in response to a presence of an object adjacent to a touch area of the light guide panel 902. The light emitter(s) 904 may transmit light to the diffraction gratings 908, and the light detector(s) 906 may detect light propagated by the light guide panel 902.

The system 900 may further include a controller 922. In various implementations, the controller 922 may determine a change in quantity of light detected by the light detector(s) 906. The controller 922 may then identify a location of the light guide panel 902 adjacent to the object based at least in part on the change.

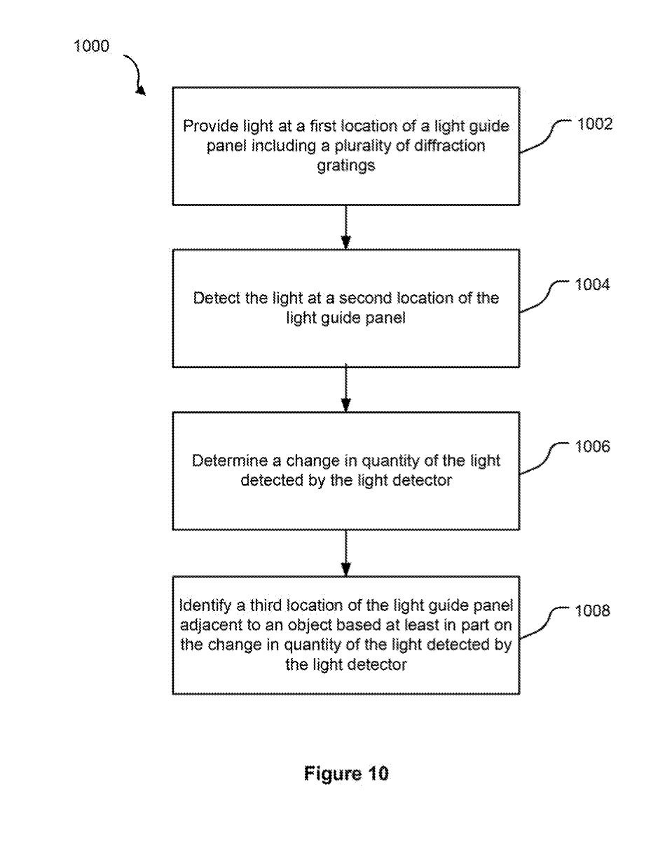

A flow diagram describing various a method 1000 for determining a location of a touch event to a light guide panel including a plurality of diffraction gratings, in accordance with various implementations described herein, is illustrated in FIG. 10. While the flow diagram illustrates various operations in a particular order, the drawing is not intended to limit the present disclosure to any particular order Additionally, the drawing is not intended to imply that all operations are required for all implementations.

Turning now to FIG. 10, the method 1000 for determining a location of a touch event to a light guide panel including a plurality of diffraction gratings may begin or proceed to block 1002 with providing light at a first location of a light guide panel including a plurality of diffraction gratings The light may be provided by a light source such as, for example, at least one light emitter. Providing light to the light guide panel at an area including the diffraction gratings may cause the light to propagate within the light guide panel by total internal reflection. The propagating light may scatter, at least in part, in response to a presence of an object adjacent to the light guide panel.

The method 1000 may proceed to block 1004 by detecting the light at a second location of the light guide panel. The light may be detected by at least one light emitter. In various implementations, a light emitter may be configured to detect light from more than one light emitter.

The method 1000 may proceed to block 1006 by determining a change in quantity of the light detected by the light detector. In various implementations, the light emitter may provide a first quantity of light to a first location of the light guide panel, and the light detector may detect a second quantity of light at the second location. The change in quantity of the light (i.e., a difference between the first quantity and the second quantity) may indicate that a touch event has occurred due at least in part to the scattering (i.e., FTIR). The change in quantity of the light is generally an attenuation of the amount of light reaching the light detector due to the scattering.

The method 1000 may proceed to block 1008 by identifying a third location of light guide panel adjacent to the object based at least in part on the change in quantity of the light detected by the light detector. In various implementations, the third location may be disposed in a touch area of the light guide panel, and in at least some of these implementations, the touch area may be defined by a periphery of the light guide panel. In some implementations, the light emitter(s) and/or the light detector(s) may be disposed along the peripheral edges of the light guide panel.

Various aspects of the illustrative embodiments are described herein using terms commonly employed by those skilled in the art to convey the substance of their work to others skilled in the art. It will be apparent to those skilled in the art that alternate embodiments may be practiced with only some of the described aspects. For purposes, of explanation, specific numbers, materials, and configurations are set forth in order to provide a thorough understanding of the illustrative embodiments. It will be apparent to one skilled in the art that alternate embodiments may be practiced without the specific details. In other instances, well-known features are omitted or simplified in order not to obscure the illustrative embodiments.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of this disclosure. Those with skill in the art will readily appreciate that embodiments may be implemented in a wide variety of ways. This application is intended to cover any adaptations or variations of the embodiments discussed herein. It is manifestly intended, therefore, that embodiments be limited only by the claims and the equivalents thereof.

What is claimed is:

1. An apparatus comprising:
a light guide panel including a plurality of diffraction gratings to cause light to propagate within the light guide panel by total internal reflection and scatter light in response to a presence of an object adjacent to the light guide panel;
a light emitter adjacent to the light guide panel to transmit light to the plurality of diffraction gratings; and
a light detector adjacent to the light guide panel to detect light propagated by the light guide panel.

2. The apparatus of claim 1, wherein the light detector detects a quantity of light from the light emitter, and wherein the scattering of light in response to the presence of the object adjacent to the light guide panel causes an attenuation of the quantity of light detected by the light detector.

3. The apparatus of claim 1, wherein the light emitter is adjacent to a first peripheral edge of a surface of the light guide panel, and wherein the light detector is adjacent to a second peripheral edge of the surface of the light guide panel.

4. The apparatus of claim 1, wherein the light guide panel includes a major surface, and wherein a touch area is defined by a periphery of the major surface.

5. The apparatus of claim 4, wherein the major surface is a first major surface, wherein the light guide panel includes a second major surface, opposite the first major surface, and wherein the light emitter and the light detector are adjacent to the second major surface of the light guide panel.

6. The apparatus of claim 1, wherein the light emitter is included among a plurality of light emitters, and wherein the light detector is included among a plurality of light detectors.

7. The apparatus of claim 1, wherein the plurality of diffraction gratings comprise a plurality of sets of substantially parallel grooves patterned to scatter light into a corresponding plurality of directional light beams into the light guide panel.

8. The apparatus of claim 7, wherein the grating pitch and the grating orientation of a set of the plurality of sets of substantially parallel grooves control the direction of light scattered by the set.

9. The apparatus of claim 7, wherein a grating length and a grating width of the set control an angular spread of light scattered by the set.

10. The apparatus of claim 1, wherein the light guide panel comprises a substrate and a film disposed over the substrate, and wherein the film includes the plurality of diffraction gratings.

11. The apparatus of claim 1, wherein the apparatus is a selected one of a display device, a desktop computer, a notebook computer, a handheld computer, a tablet or slate computer, a convertible computer, a smart phone, a personal digital assistant, a mobile phone, a television, a retail point of sale computer, a gaming computer, or a digital camera.

12. A method comprising:
providing light at a first location of a light guide panel including a plurality of diffraction gratings to cause the light to propagate within the light guide panel by total internal reflection and scatter, at least in part, in response to a presence of an object adjacent to the light guide panel;
detecting the light at a second location of the light guide panel; and
identifying a third location of light guide panel adjacent to the object based at least in part on a change in quantity of the light detected by the light detector.

13. The method of claim 12, further comprising determining the change in quantity of the light detected by the light detector.

14. The method of claim 12, wherein said providing the light comprises providing a first quantity of light to the first location, wherein said detecting the light comprises detecting a second quantity of light, at the second location, and wherein the method further comprises determining a difference between the first quantity and the second quantity.

15. An apparatus comprising:
a display including a light guide panel having a plurality of diffraction gratings to cause light to propagate within the light guide panel by total internal reflection, a light emitter adjacent to the light guide panel to transmit light to the light guide panel through the plurality of diffraction gratings, and a light detector adjacent to the light guide panel to detect light propagated by the light guide panel; and
a controller to determine a change in quantity of light detected by the light detector, and identify a location of a touch event based at least in part on the change.
